(19) United States
(12) Patent Application Publication
(10) Pub. No.: US 2015/0356737 A1
(43) Pub. Date: Dec. 10, 2015

(54) SYSTEM AND METHOD FOR MULTIPLE SENSOR FIDUCIAL TRACKING

(71) Applicant: Ken Clements, Los Gatos, CA (US)

(72) Inventors: Jeri J. Ellsworth, San Jose, CA (US); Ken Clements, Los Gatos, CA (US)

(73) Assignee: TECHNICAL ILLUSIONS, INC., Mountain View, CA (US)

(21) Appl. No.: 14/733,708

(22) Filed: Jun. 8, 2015

Related U.S. Application Data
(60) Provisional application No. 62/009,797, filed on Jun. 9, 2014.
(60) Provisional application No. 62/012,911, filed on Jun. 16, 2014.
(60) Provisional application No. 62/165,089, filed on May 21, 2015.

(51) Int. Cl. G06T 7/00; G06F 3/01; H04N 5/225; H04N 5/247; G06T 7/20

(52) U.S. Cl. CPC G06T 7/0044; H04N 5/247; G06T 7/202; G06T 7/204; H04N 5/2256; G06F 3/011

(57) ABSTRACT

In a head mounted virtual reality or augmented reality system, a fast but lower resolution second camera is added and used to quickly find an area of a visual field returned by a slower but higher resolution first camera, where that area is likely to contain the image of a marker for a head tracking system or a hand held device.

### RELATED APPLICATIONS

The present application claims the benefit of provisional patent application No. 62/009,797 filed on Jun. 9, 2014, entitled “MULTIPLE SENSOR TRACKING SYSTEM WITH SUB WINDOW CONTROL” by Jeri J. Ellsworth and Ken Clements, and provisional patent application No. 62/012,911, filed on Jun. 16, 2014, entitled “FIDUCIAL ACTIVATION BY STIMULATED FLUORESCENCE” by Ken Clements, and provisional patent application No. 62/165,089 filed on May 21, 2015, entitled “RETROREFLECTIVE FIDUCIAL SURFACE” by Jeri J. Ellsworth et al., the entire contents of which are fully incorporated by reference herein.

### U.S. PATENT DOCUMENTS

U.S. Pat. No. 7,120,875 B2 10/2006 Daily et al.

U.S. Pat. No. 7,127,082 B2 10/2006 Neely

U.S. Pat. No. 7,996,097 B2 10/2006 DiBernardo et al.

U.S. Pat. No. 8,031,227 B2 10/2011 Neal et al.

U.S. Pat. No. 8,077,914 B1 12/2011 Kaplan

U.S. Pat. No. 8,224,024 B2 7/2012 Foxlin et al.

U.S. Pat. No. 8,696,458 B2 4/2014 Foxlin et al.

U.S. Pat. No. 8,724,848 B1 5/2014 Heath et al.

2012/0320216 A1 12/2012 Mkrtchyan et al.

2014/0340424 A1 11/2014 Ellsworth

### OTHER PUBLICATIONS

K. Dorfmüller, “Robust tracking for augmented reality using retroreflective markers.” Computers & Graphics 23.6 (1999): 795-800.

J. P. Rolland, L. Davis and Y. Baillot, “A survey of tracking technology for virtual environments.” Fundamentals of wearable computers and augmented reality 1 (2001): 67-112.

E. Foxlin, and G. Welch, “Motion Tracking: No Silver Bullet, but a Respectable Aresnal.” IEEE Computer Graphics and Applications (2002).

F. Ababsa and M. Mallem, “A robust circular fiducial detection technique and real-time 3d camera tracking ” Journal of Multimedia 3.4 (2008): 34-41.

### FIELD OF THE INVENTION

This invention applies to “head tracking” or “camera pose” or “line of sight” determination in head mounted, or hand held, display systems used for virtual reality or augmented reality applications.

### DESCRIPTION OF THE RELATED ART

Many systems exist today in which a head mounted display contains means to calculate the position or “pose” of the display as it moves through 3D space and renders images based on what would be seen from that position or pose. One such means takes the form of a camera mounted on the frame of a head mounted display, such camera able to look out along the user's line of sight and return images of objects along that path. This technique often uses a predetermined object or “marker” to act as a fiducial indicator, through which, received images at the camera may be analyzed against reference shape data to calculate the position of the camera necessary to match the received image, such as taught by Neely in U.S. Pat. No. 7,127,082 and Ellsworth in US application 2014/0340424.

The camera and marker system is limited by the resolution of the camera and the time it takes to process the images it returns. This limitation sets up a trade-off between how fast motion can be tracked versus how accurately position can be measured.

### SUMMARY

In a head mounted virtual reality or augmented reality system, a fast but lower resolution second camera is added and used to quickly find an area of a visual field returned by a slower but higher resolution first camera, where that area is likely to contain the image of a marker for a head tracking system or a hand held device.

### BRIEF DESCRIPTION OF THE DRAWINGS

FIG. 1.—Prior Art—A head mounted display with marker tracking camera.

FIG. 2.—A head mounted display with multiple marker tracking cameras.

FIG. 3.—A “marker” pattern used as a fiducial indicator.

FIG. 4.—Image returned by “fast” sensor.

FIG. 5.—Image returned by “hi-res” sensor.

### DETAILED DESCRIPTION

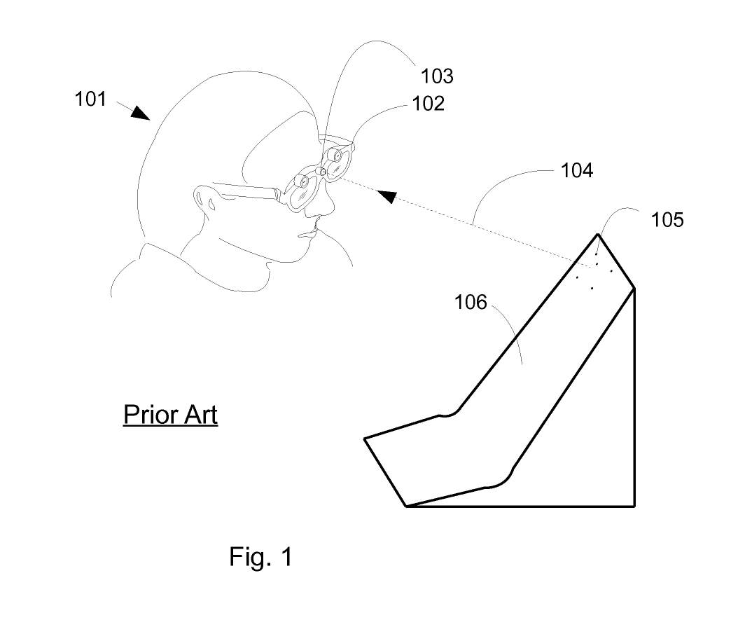

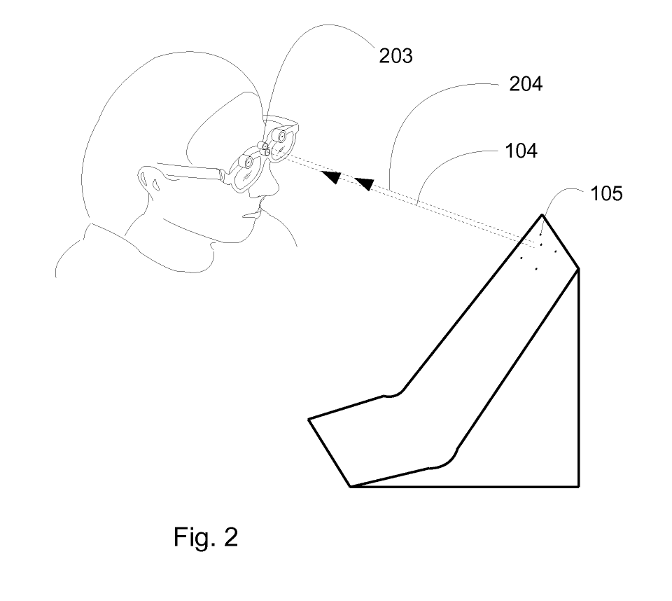

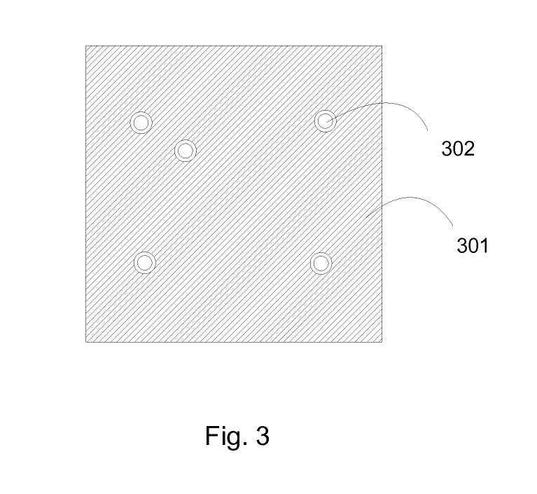

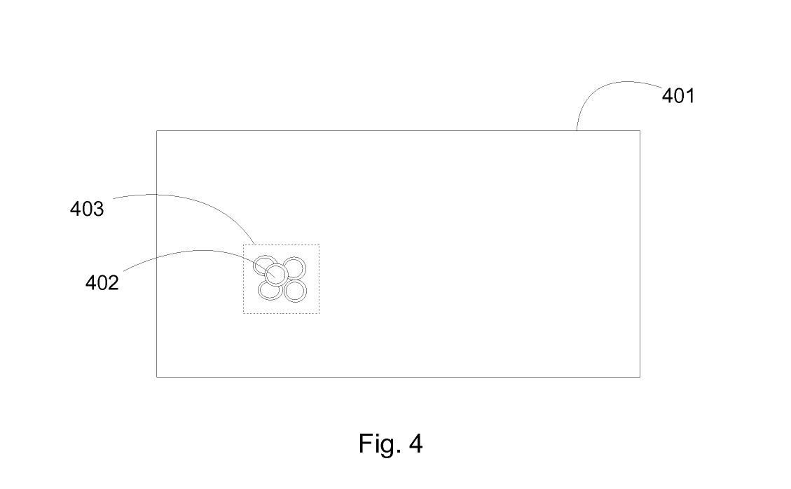

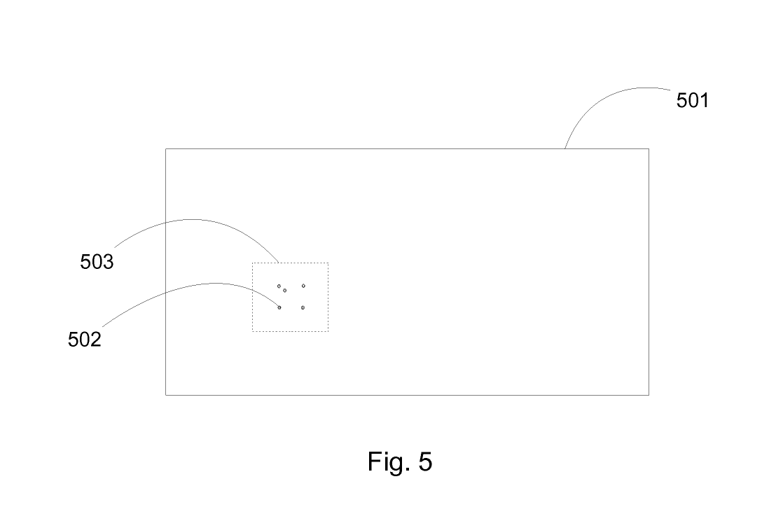

The prior art is shown in FIG. 1, in which a pattern of infrared LED emitters 105 mounted on a retroreflective surface 106 shine light 104 to be picked up by the camera 103 located in the center of the head mounted display 102 worn by user 101. This system relies on software algorithms to search returned images to find patterns that represent the shape of the marker (301 with emitters 302 shown in FIG. 3) as seen from various distances and at various angles. This system can be greatly improved as shown in FIG. 2, by the addition of a second camera 203, which returns images much faster than the first camera 103, but at a trade-off of lower resolution. However, whereas the resolution returned by the second camera 203 may not be enough to resolve the desired fiducial points, it is equipped with the necessary resolution and lens system to return an image (401 shown in FIG. 4) that is sufficient to determine a region 403 where potential fiducial points 402 will be present in the high resolution image (501 shown in FIG. 5) returned by camera one 103. Working together, the images from the cameras can be used to quickly return high resolution data as extracted from the images produced by the first camera 103 as selected by data region 503 corresponding to region 403 from the second camera 203. The region 403 may be completely indistinct with regard to resolving individual fiducial points, but the detection of this region by camera 203 saves processing time in the location of fiducial points in the image returned by camera 103. This time savings may be in the form of restricting the algorithmic searching of a fully returned image from camera 103, or may be achieved by instructing camera 103 to only return data from the smaller restricted region.

As a further advantage of the two camera system, the frames that are produced quickly by camera 203 can be used to infer motion between the times of arrival of high resolution frames from camera 103. The most common head motion is panning from side to side and the tilting between upper and lower views. In these motions the indistinct image received quickly on camera 203 is seen to shift laterally for panning, and vertically for up and down tilts. A close approximation of what would be intermediate frames on the high resolution camera 103 during these intermediate times can be inferred from the overall movement seen on camera 203, and from that inference new display frames in the head mounted display, or hand held device, can be generated to give the user the impression of faster tracking ability.

A two camera embodiment has been presented, but those skilled in the art will understand that image sensors in cameras can be made to have characteristics that can be modified programmatically during operation. In such an embodiment, a single physical camera would be switched from fast-scan/low-resolution mode to slower high resolution mode as it gathers frames. This embodiment achieves much of the operation of the simultaneous action of two independent physical cameras.

In contrast to a single added camera 203 embodiment, it is also possible for multiple fast cameras to be tasked to cover tiled or overlapping fields of view. In such an embodiment, the plurality of cameras simulates a higher resolution situation at the same fast sampling rate. For some applications an array of fast low-resolution cameras, each returning images of a small part of a bigger image field, may do the entire image processing task by working together.

The invention should not be construed to be limited to application in only head mounted displays, but has general applicability in any device that requires information specifying position and orientation, or pose. An example of such an embodiment would be in game controllers that are held in the hands of users and moved in gesture arcs to communicate control information or manipulate virtual objects.

A further benefit of the camera 203 addition is that by synchronizing to active LED fiducial light emitters, the fast camera 203 can record an image when the LEDs are in an off phase of their duty cycle so as to record a background image of false targets if there are such. The false target image can then be subtracted from an image taken in the active part of the fiducial duty cycle, causing interfering light sources to be reduced in contrast to desired fiducial images. Although the embodiments shown rely on markers comprising active emitters, those of ordinary skill in the art will understand that the invention may be practiced with passive reflecting or fluorescing markers, as taught in applications 62/012,911 and 62/165,089, and that the contrast of images of said markers may also be enhanced by differencing returned frames having differing marker illumination.

### CONCLUSION

An illustrative embodiment has been described by way of example herein. Those skilled in the art will understand, however, that change and modifications may be made to this embodiment without departing from the true scope and spirit of the elements, products, and methods to which the embodiment is directed, which is defined by our claims.

We claim:

1. A system for tracking the position and motion of an electronic device comprising:
an electronic device;
a first camera attached to said electronic device, said first camera returning high resolution images of external objects, where said images may contain tracking fiducial points of reference;
one or more second cameras also attached to said electronic device, said second camera or cameras returning lower resolution images than returned by said first camera, but at higher frame rates than said first camera;
an image processing means that quickly processes the entire frame or frames returned by said second camera or cameras so as to find an area of search to apply to the processing of images from said first camera, where said area of search reduces the processing necessary in images from said first camera in order to locate said fiducial points.

2. The system according to claim 1 in which image changes in said area of search from frame to frame returned by said second camera or cameras, are processed by algorithms to predict changes in data from the subsequent frames returned by said first camera.

3. The system according to claim 1 in which said electronic device comprises a head mounted video display.

4. The system according to claim 1 in which said electronic device comprises a hand held video game controller.

5. The system according to claim 1 in which said second image sensor is, or sensors are, implemented as a change of mode of operation of said first image sensor.

6. A method to improve the usefulness of fiducial points in a position or orientation tracking system comprising the steps:
a. providing an electronic device with a first image sensor or camera and one or more second image sensors or cameras, said first image sensor having high resolution capabilities and said second sensor or sensors having high frame rate capabilities;
b. providing one or more patterns of light emitting, or reflecting, fiducial indicators external to said electronic device;
c. collecting image frames from both said first and second image sensors;
d. using movement analysis of the image frames returned by said second image sensor or sensors to predict corresponding movement of fiducial points in subsequent image frames by said first image sensor.

7. A method to improve the image of fiducial points in a position or orientation tracking system comprising the steps:
a. providing an electronic device with an image sensor or camera;
b. providing one or more patterns of light emitting or reflecting fiducial indicators external to said electronic device;
c. operating said fiducial indications in a synchronized duty cycle of time slots for active emission or reflection;
d. collecting image frames from said image sensor during both active and inactive parts of said duty cycle of said fiducial indicators;
e. subtracting said inactive cycle images from said active cycle images so as to increase the contrast of fiducial images with respect to background image sources.

8. The method of claim 7 in which said fiducial indicators are light emitters and are activated by controlling or modulating power to light emitters.

9. The method of claim 7 in which said fiducial indicators are reflective and are activated by controlling or modulating illumination.

10. The method of claim 7 in which said fiducial indicators are fluorescent and are activated by controlling or modulating illumination causing said fluorescence.
